(19) United States
(12) Patent Application Publication
(10) Pub. No.: US 2025/0062417 A1
(43) Pub. Date: Feb. 20, 2025

(54) Carbon-Based Bipolar Membranes for Bipolar Stacked Solid-State Batteries

(71) Applicant: United States of America as represented by the Administrator of NASA, Washington, DE (US)

(72) Inventors: Yi Lin, Yorktown, VA (US); John W. Connell, Yorktown, VA (US); Bona Y. Kim, Duluth, GA (US); Rocco P. Viggiano, Elyria, OH (US); Donald A. Dornbusch, North Olmsted, OH (US)

(21) Appl. No.: 18/235,619

(22) Filed: Aug. 18, 2023

(51) Int. Cl. H01M 10/0585; H01M 4/04; H01M 4/134; H01M 4/38; H01M 10/0562; H01M 50/531

(52) U.S. Cl. CPC H01M 10/0585; H01M 4/043; H01M 4/134; H01M 4/382; H01M 10/0562; H01M 50/531; H01M 2004/027; H01M 2004/028; H01M 2300/008

(57) ABSTRACT

Lightweight, electrically conductive, and mechanically robust carbon nanomaterials in the form of films and membranes are used as electrochemically inert bipolar membranes for bipolar-stacked solid state batteries (SSBs). Bipolar plates are electrochemically inert and electrically conductive layers serially connecting adjacent solid-state unit cells but isolating the electrochemistry in each individual cell. The use of bipolar plates to form bipolar stacks is unique to SSBs. Such arrangement would significantly reduce the battery packaging weight because there is no need to seal and provide external connections to each individual unit cells as required in conventional batteries with liquid electrolytes. Reducing the weight of bipolar plates without compromising their other requirements especially electrical conductivity is highly desirable in improving the overall specific energy for packaged bipolar SSB stacks.

### STATEMENT REGARDING FEDERALLY SPONSORED RESEARCH OR DEVELOPMENT

For Government employee only inventions: The invention described herein was made by an employee/employees of the United States Government and may be manufactured and used by or for the Government of the United States of America for governmental purposes without the payment of any royalties thereon or therefore.

### BACKGROUND OF THE INVENTION

Next generation electric aircraft require advanced technologies beyond lithium-ion chemistries which are both high performance and safe under typical flight conditions. Advanced lithium-ion chemistries must possess high performance characteristics including a high specific energy as well as a non-flammable design. Solid state batteries (SSBs) are a leading contender to replace lithium-ion batteries for electric aviation because it utilizes a non-flammable solid electrolyte with a high energy density cathode, such as lithium-sulfur, to enable future aerospace missions. To achieve ultimate energy density, all components of the battery packs, including the cathode, anode, solid electrolyte, current collectors, and packaging materials, must be optimized for highest energy output per unit weight. A key advantage of SSBs, when comparing them to conventional batteries with liquid electrolyte, is that the unit SSB cells can be directly stacked, only separated by an electrically conductive but inert bipolar plate. In comparison, the unit cells of conventional liquid electrolyte batteries must be individually sealed and externally connected to prevent ionic short circuit. The use of a bipolar plate can also enable high voltage applications by simply stacking and serially connecting the unit cells. While the use of bipolar plates is an effective approach to improve specific energy of the battery pack, reducing the weight of bipolar plate is a significant advancement compared to the state-of-the-art to increase overall energy density. The objective is to fabricate lightweight and effective bipolar plates for SSBs.

Stainless steel, titanium, aluminum, aluminum-copper bilayer clads, and carbon-fluoropolymer composites have been reported as bipolar plates. Stainless steel and titanium are inert to most battery electrochemistries, but possess relatively high densities (7.9 and 4.5 g/cm³, respectively). Aluminum ones are lighter in density (Al: 2.7 g/cm³), but aluminum-copper bilayer clads can still be heavy (Cu: 9.0 g/cm³). Aluminum and copper-based bipolar plates are of limited electrochemical voltage range. Aluminum is known to form alloys with lithium metal (a typical anode for high energy batteries), while copper reacts with sulfur (a typical cathode for high energy batteries). Conductive ceramics such as metal carbides and nitrides still possess high densities TiC: 4.93 g/cm³, TiN: 5.4 g/cm³. Carbon-fluoropolymer composites have been used as a bipolar plate for redox flow batteries and are commercially available (https://www.sglcarbon.com/en/markets-solutions/material/sigracell-bipolar-plates/).

In these composites, carbon provides electrical conductivity and the polymer provides mechanical strength. However, with the presence of non-conductive polymer, the per weight electrical conductivity of the composite bipolar plate is reduced significantly, thus limiting the power performance of the bipolar stack. Additionally, high energy alkali metal electrodes have high reactivity towards fluorocarbons and binder compatibility remains a major concern. Traditional metallic foils possess extremely low surface roughness, which can inhibit adhesion and limit electron transport to the active material. Carbon materials may provide much improved interface contact with the electrode for enhanced electron transport.

### BRIEF SUMMARY OF THE INVENTION

The present invention is solid-state batteries (SSBs) that use lightweight, electrically conductive, and mechanically robust carbon nanomaterials in the form of films and membranes for electrochemically inert bipolar plates.

One embodiment of the invention is a solid-state battery comprising: a plurality of unit cells, wherein each of the plurality of unit cells includes a cathode, an electrolyte, and an anode; one or more carbon-based bipolar membranes, wherein each of the carbon-based bipolar membrane separates two of the plurality of unit cells; a cathode current collector that provides a positive pole for the solid-state battery; and an anode current collector that provides a negative pole for the solid-state battery. The plurality of unit cells may include a first unit cell and a second unit cell. The carbon-based bipolar membrane may be a conductive carbon nanomaterial film. Additionally, the carbon-based bipolar membrane may have a density of less than 0.5 g/cm³, a mass loading of less than 10 mg/cm², and/or a thickness of less than 100 μm. The carbon-based bipolar membrane may be a holey graphene powder that is directly pressed with a sulfur-based solid-state cathode composite powder and a solid electrolyte lithium phosphorous sulfide chloride powder using a solvent-free dry compression process under a pressure of 100 MPa, thereby forming a holey graphene-cathode-solid electrolyte trilayer. A first lithium metal anode may be attached to a solid electrolyte layer side of the holey graphene-cathode-solid electrolyte trilayer to form a first unit cell with a holey graphene-based bipolar membrane attached. A second lithium metal anode is attached to a cathode-solid electrolyte bilayer using the solvent-free dry compression process under the pressure of 100 MPa, thereby forming a second unit cell. The second lithium metal anode of the second unit cell may contact a holey graphene side of the first unit cell.

Another embodiment of the invention is solid-state battery comprising: a first holey graphene-cathode-solid electrolyte trilayer; a second holey graphene-cathode-solid electrolyte trilayer; and a cathode-solid electrolyte bilayer. The first holey graphene-cathode-solid electrolyte trilayer may include a first holey graphene powder that is directly pressed with a first sulfur-based solid-state cathode composite powder and a first solid electrolyte lithium phosphorous sulfide chloride powder using a solvent-free dry compression process. The second holey graphene-cathode-solid electrolyte trilayer may include a second holey graphene powder that is directly pressed with a second sulfur-based solid-state cathode composite powder and a second solid electrolyte lithium phosphorous sulfide chloride powder using the solvent-free dry compression process. The cathode-solid electrolyte bilayer may include a third sulfur-based solid-state cathode composite powder and a third solid electrolyte lithium phosphorous sulfide chloride powder compressed together using the solvent-free dry compression process, thereby forming a second unit cell. Additionally, a first lithium metal anode may be inserted between an open side of the third solid electrolyte lithium phosphorous sulfide chloride powder of the cathode-solid electrolyte bilayer and the first holey graphene powder of the first holey graphene-cathode-solid electrolyte trilayer. A second lithium metal anode may be inserted between an open side of the first solid electrolyte lithium phosphorous sulfide chloride powder of the first holey graphene-cathode-solid electrolyte trilayer and the second holey graphene powder of the second holey graphene-cathode-solid electrolyte trilayer. A third lithium metal anode may be attached to an open side of the second solid electrolyte lithium phosphorous sulfide chloride powder of the second holey graphene-cathode-solid electrolyte trilayer.

Yet another embodiment of the invention is a solid-state battery comprising: a first unit cell component that includes a first lithium anode attached to a solid electrolyte side of a first cathode-solid electrolyte bilayer formed by a solvent-free dry compression process; a second unit cell component that includes a second lithium anode attached to a solid electrolyte side of a second cathode-solid electrolyte bilayer formed by the solvent-free dry compression process; and a carbon nanotube sheet bipolar plate that separates the first unit cell and the second unit cell and provides a serial electrical connection between the first unit cell and the second unit cell.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a depiction of a dual-cell bipolar solid-state battery (SSB) stack architecture according to embodiments of this invention, with two unit cells separated by a carbon-based bipolar plate;

FIG. 2 is a chart showing the first discharge-charge cycles of various SSB cell configurations according to embodiments of the present invention;

FIG. 3 is a depiction of a tri-cell bipolar SSB stack architecture according to embodiments of this invention, with three unit cells separated by two carbon-based bipolar plates;

FIG. 4 is a depiction of another dual-cell bipolar SSB stack architecture according to embodiments of this invention, with two unit cells separated by a carbon nanotube sheet bipolar plate; and

FIG. 5 is an exemplary performance chart of a bi-cell bipolar SSB stack with a two-unit-cell ensemble and a carbon nanotube sheet bipolar plate.

### DETAILED DESCRIPTION OF THE INVENTION

For purposes of description herein, the terms “upper,” “lower,” “right,” “left,” “rear,” “front,” “vertical,” “horizontal,” and derivatives thereof shall relate to the invention as oriented in the figures. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Lightweight, electrically conductive, and mechanically robust carbon nanomaterials in the form of films and membranes are used as electrochemically inert bipolar plates for bipolar-stacked solid state batteries (SSBs). The carbon nanomaterials may include, but not be limited to, one or more of the following: graphite, expanded graphite, exfoliated graphite, graphene, holey graphene, graphene oxide, reduced graphene oxide, carbon platelets, carbon nanotubes, carbon fibers, carbon nanofibers, carbon nanoribbons, carbon nanobelts, carbon black, activated carbon, ketjen black, biomass carbons, ordered/disordered mesoporous carbon. Bipolar plates are electrochemically inert and electrically conductive layers serially connecting adjacent solid-state unit cells but isolating the electrochemistry in each individual cell. The use of bipolar plates to form bipolar stacks is unique to SSBs. Such arrangement would significantly reduce the battery packaging weight because there is no need to seal and provide external connections to each individual unit cells as required in conventional batteries with liquid electrolytes. Reducing the weight of bipolar plates without compromising their other requirements especially electrical conductivity is highly desirable in improving the overall specific energy for packaged bipolar SSB stacks.

One of the state-of-the-art choices for bipolar plates is stainless steel, which is of ˜7.9 g/cm³ in density. This invention demonstrates that carbon nanomaterials, such as holey graphene, graphene, and carbon nanotubes, can be fabricated into bipolar plates for bipolar-stacked SSBs. The carbon-based bipolar plates are also electrically conductive and mechanically strong, but may have a density of only of approximately 1.5 g/cm³ or less or approximately 2.5 g/cm³ or less, thus significantly lighter than stainless steel ones. Note: consider carbon associated with metal additives for lithiophobic properties; those would be heavier. The carbon-based bipolar plates are applicable to SSBs with various battery chemistries, providing opportunities to fabricate bipolar stacked SSBs with much enhanced specific energy compared to those comprised of stainless steel. High energy density bipolar stacked solid-state batteries are non-flammable with broad applications in electronics, robotics, electric vehicles, electric aviation, grid storage and other energy storage needs.

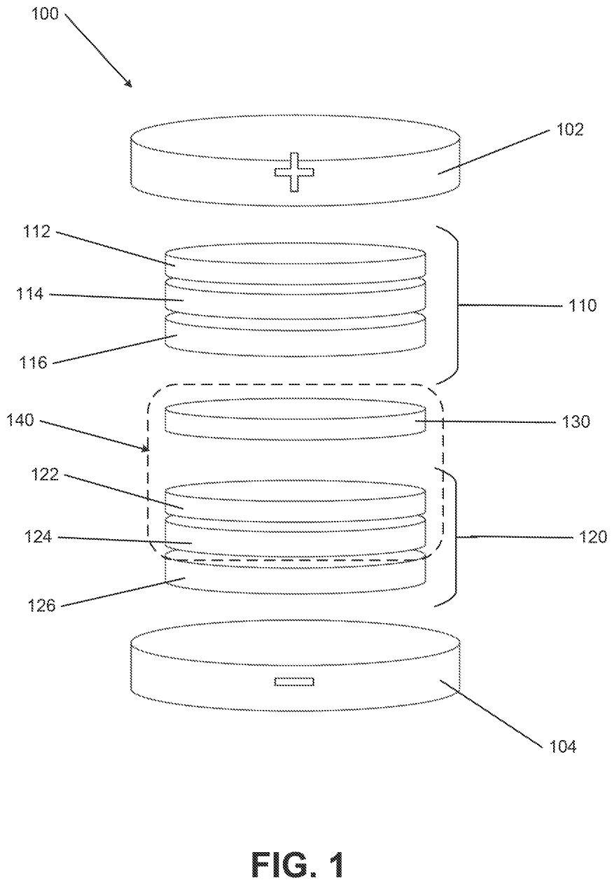

FIG. 1 depicts an exemplary embodiment of a dual-cell bipolar stack 100 architecture in this invention, with two unit cells 110, 120 separated by a carbon-based bipolar membrane 130. The carbon-based membrane 130 as depicted and described throughout may also be described as a foil, a sheet, a film, a plate, a layer, a laminate, a paper and/or any other structure that may be used to separate the unit cells 110, 120 without departing from the invention. The carbon-based membrane 130 may be a hard surface or a soft surface. The carbon-based membrane 130 may also be porous or non-porous.

As depicted in FIG. 1, carbon-based bipolar membranes 130 may be used to separate unit cells 110, 120 of SSBs and provide serial electrical connection between adjacent unit cells. While FIG. 1 depicts a dual-cell bipolar SSB stack 100, the bipolar SSB stack 100 may include other numbers of cells, such as three, four, five, etc. cells. The bipolar SSB stack 100 may also have tens or even hundreds of bipolar cells if desired. The carbon-based bipolar membranes 130 may include, but not be limited to, one or more of the following: graphite, expanded graphite, exfoliated graphite, graphene, holey graphene, graphene oxide, reduced graphene oxide, carbon platelets, carbon nanotubes, carbon fibers, carbon nanofibers, carbon nanoribbons, carbon nanobelts, carbon black, activated carbon, ketjen black, biomass carbons, ordered/disordered mesoporous carbon.

FIG. 1 specifically illustrates a dual-cell bipolar SSB stack 100 that includes a first unit cell 110 and a second unit cell 120 that are separated by a carbon-based bipolar membrane or plate 130. The first unit cell 110 may include in order, a cathode 112, a solid electrolyte 114, and an anode 116. Similarly, the second unit cell 120 may include in order, a cathode 122, a solid electrolyte 124, and an anode 126. The cathode 112, 122 may include, but not be limited to, one or more of the following: sulfur(S); selenium (Se); selenium sulfide compounds (SeₓS;); lithium iron phosphate (LFP); lithium cobalt oxide (LCO); lithium manganese oxide (LMO); lithium nickel manganese cobalt oxide (NMC), lithium titanium oxide (LTO); metal sulfides: FeS₂, FeS, TiS₂, CuS, CoS; or metal halides: FeX₃, FeX₂, CuX, CuX₂, NiX₂, X=(Cl, F, Br, I). The electrolyte 114, 124 may include, but not be limited to, one or more of the following: sulfides, oxides, halides, borohydrides, polymers, mixtures and composites thereof, or those with and without binders or additives. The anode 116, 126 may include, but not be limited to, one or more of the following: alkali and alkali earth metals, such as lithium (Li), sodium (Na), aluminum (Al), potassium (K), magnesium (Mg), calcium (Ca); or alloy-based anodes such as lithium with Si, SiOₓ, Sn, Al, Zn, Mg, Ag, In.

As illustrated in FIG. 1, the dual-cell bipolar stack 100 may include a cathode current collector 102 adjacent to the first unit cell 110 which is a positive pole for the dual-cell bipolar stack 100. Additionally, the dual-cell bipolar stack 100 may include an anode current collector 104 adjacent to the second unit cell 120 which is a negative pole for the dual-cell bipolar stack 100.

While the state-of-the-art bipolar plates use high density, heavy metals or less electrically conductive carbon-based composites, the direct use of conductive carbon nanomaterial films or membranes described in this invention allows the bipolar membranes 130 to be fabricated with both high electrical conductivity and low density. These bipolar membranes 130 provide a significant improvement of SSB performance in both specific energy due to their lighter weights and specific power due to the high electrical conductivity. An important feature of this invention is that the carbon-based bipolar membranes 130 may be of low density, low mass loading, and low thickness. For example, the density may be <0.5-1.5 g/cm³ or less than 2.5 g/cm³. Additionally, the mass loading may be approximately 10 mg/cm² and the thickness may be less than 100 μm. Several embodiments are introduced below as examples but not as limitations on how carbon-based bipolar membranes 130 are fabricated.

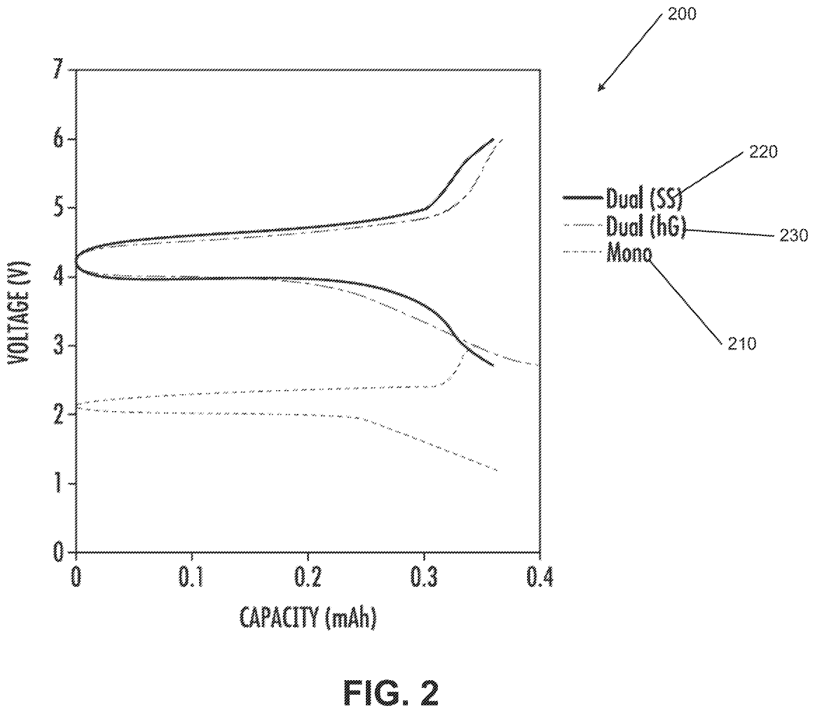

In one embodiment, holey graphene powder 130 may be directly pressed with sulfur-based solid-state cathode composite powder 122 and the solid electrolyte lithium phosphorous sulfide chloride (LPSCl) powder 124 in a solvent-free dry compression process under a pressure of 100 MPa, forming a holey graphene-cathode-solid electrolyte trilayer 140. Lithium (Li) metal anode 126 may be attached to the solid electrolyte layer side 124 to form one SSB unit cell 120 with a holey graphene-based bipolar membrane 130 already attached. Another unit cell 110 may be formed by the attachment of a Li metal anode 116 to a cathode-solid electrolyte bilayer 112, 114 similarly prepared via the same dry compression technique. The first unit cell 110 is then stacked onto the second unit cell 120, with the Li metal anode 116 and cathode-solid electrolyte bilayer 112, 114 of the first cell 110 contacting the holey graphene-based bipolar membrane 130 of the second cell 120. Encasing the two-unit-cell ensemble into a coin cell, a pouch cell, a cylindrical cell, or a split cell forms a dual-cell bipolar SSB stack 100. An example performance of such dual-cell bipolar stack 100 is shown in FIG. 2.

FIG. 2 depicts a chart 200 showing the first discharge-charge cycles of various battery cell configurations. Specifically, FIG. 2 depicts the first discharge-charge cycles at room temperature (R.T.) of 2032-sized coin cells encased with one unit cell (“Mono”) 210, a dual-cell bipolar stack with a stainless steel (SS) bipolar membrane (200 μm; 250 mg) [“Dual (SS)”] 220, and a dual-cell bipolar stack with a directly dry-pressed holey graphene (hG) bipolar membrane (˜85 μm; 15 mg) [“Dual (hG)”] 230. The data shows that the performance of Dual (hG) 230 is identical to that of Dual (SS) 220, despite the much lighter hG-based bipolar membrane vs. the SS-based one. Meanwhile, the dual-cell bipolar stacks 220, 230 may exhibit twice the voltage but similar capacity values to the mono-cell 210, suggesting ideal performance from the bipolar stack architectures. In this example, the solid electrolyte layer is lithium phosphorous sulfide chloride (LPSCl). Additionally, in this example, the cathode is sulfur-based solid-state cathode composite with hG as the carbon additive and LPSCl as the solid electrolyte additive. Lastly, in this example, the anode was Li metal. Various other electrolyte layers, cathodes, and anodes can be used as appropriate.

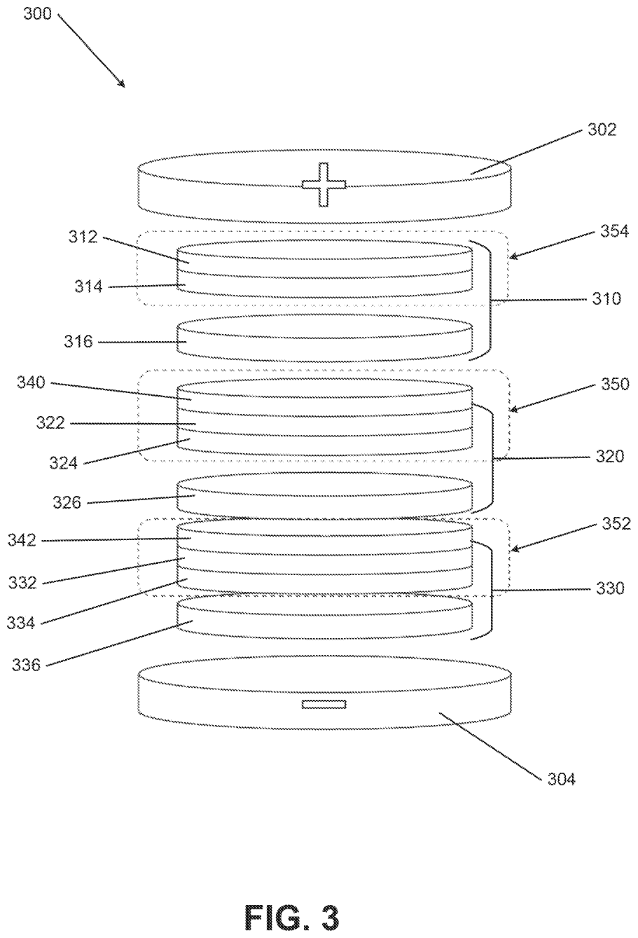

FIG. 3 depicts another exemplary embodiment of a tri-cell bipolar SSB stack 300 architecture in this invention, with three unit cells 310, 320, 330 separated by two carbon-based bipolar membranes 340, 342. The carbon-based membranes 340, 342 as depicted and described throughout may also be described as a foil, a sheet, a film, a plate, a layer, a laminate, a paper and/or any other structure that may be used to separate the unit cells 310, 320, 330 without departing from the invention. The carbon-based membranes 340, 342 may be a hard surface or a soft surface. The carbon-based membranes 340, 342 may also be porous or non-porous. This tri-cell bipolar stack 300 may include a compressible holey graphene compressed onto the cathode surface so that the bipolar membranes 340, 342 can be manufactured together with the cathode and the solid state electrolyte.

As depicted in FIG. 3, carbon-based bipolar membranes 340, 342 may be used to separate unit cells 310, 320, 330 of SSBs and provide serial electrical connection between adjacent unit cells. While FIG. 3 depicts a tri-cell bipolar SSB stack 300, the bipolar SSB stack 300 may include other numbers of cells, such as two, four, five, etc. cells. The bipolar SSB stack 300 may also have tens or even hundreds of bipolar cells if desired. The carbon-based bipolar membranes 340, 342 may include, but not be limited to, one or more of the following: graphite, expanded graphite, exfoliated graphite, graphene, holey graphene, graphene oxide, reduced graphene oxide, carbon platelets, carbon nanotubes, carbon fibers, carbon nanofibers, carbon nanoribbons, carbon nanobelts, carbon black, activated carbon, ketjen black, biomass carbons, ordered/disordered mesoporous carbon.

For the embodiments of FIG. 3, the features are referred to using similar reference numerals under the “3xx” series of reference numerals, rather than “1xx” as used in the embodiment of FIG. 1. Accordingly, certain features of the bipolar SSB stack 300 that were already described above with respect to the bipolar SSB stack 100 of FIG. 1 may be described in lesser detail, or may not be described at all.

As illustrated in FIG. 3, the first unit cell 310 may include a cathode 312, a solid electrolyte 314, and an anode 316. The second unit cell 320 may include a cathode 322, a solid electrolyte 324, and an anode 326. The third unit cell 330 may include a cathode 332, a solid electrolyte 334, and an anode 336. The cathode 312, 322, 332 may include, but not be limited to, one or more of the following: sulfur(S); selenium (Se); selenium sulfide compounds (SeₓS_{y}); lithium iron phosphate (LFP); lithium cobalt oxide (LCO); lithium manganese oxide (LMO); lithium nickel manganese cobalt oxide (NMC), lithium titanium oxide (LTO); metal sulfides: FeS₂, FeS, TiS₂, CuS, CoS; or metal halides: FeX₃, FeX₂, CuX, CuX₂, NiX₂, X=(Cl, F, Br, I). The electrolyte 314, 324, 334 may include, but not be limited to, one or more of the following: sulfides, oxides, halides, borohydrides, polymers, mixtures and composites thereof, or those with and without binders or additives. The anode 316, 326, 336 may include, but not be limited to, one or more of the following: alkali and alkali earth metals, such as lithium (Li), sodium (Na), aluminum (Al), potassium (K), magnesium (Mg), calcium (Ca); or alloy-based anodes such as lithium with Si, SiOₓ, Sn, Al, Zn, Mg, Ag, In.

The tri-cell bipolar stack 300 may include a cathode current collector 302 adjacent to the first unit cell 310 which is a positive pole for the tri-cell bipolar stack 300. The tri-cell bipolar stack 300 may include an anode current collector 304 adjacent to the third unit cell 330 which is a negative pole for the tri-cell bipolar stack 300.

While the state-of-the-art bipolar plates use high density, heavy metals or less electrically conductive carbon-based composites, the direct use of conductive carbon nanomaterial films or membranes described in this invention allows bipolar membranes 340, 342 to be fabricated with both high electrical conductivity and low density. These bipolar membranes 340, 342 provide a significant improvement of SSB performance in both specific energy due to their lighter weights and specific power due to the high electrical conductivity. An important feature of this invention is that the carbon-based bipolar membranes 130 may be of low density, low mass loading, and low thickness. For example, the density may be <0.5-1.5 g/cm³ or less than 2.5 g/cm³. Additionally, the mass loading may be approximately 10 mg/cm²) and the thickness may be less than 100 μm). Several embodiments are introduced below as examples but not as limitations on how carbon-based bipolar membranes 340, 342 are fabricated.

The two carbon-based membranes 340, 342 may be included as a holey graphene-based bipolar trilayer 350, 352. The holey graphene bipolar trilayer 350, 352 may be fabricated by directly pressing holey graphene powder or carbon-based membrane 340, 342 with cathode powder and solid electrolyte. For example, the first holey graphene bipolar trilayer 350 may be fabricated by directly pressing the carbon-based membrane or holey graphene powder 340 with the cathode powder from the second unit cell powder in a layered fashion. Two of such trilayers are stacked with three Li anodes and a cathode-electrolyte bilayer to form a tri-cell bipolar stack, as depicted in FIG. 3.

FIG. 3 illustrates two holey graphene-cathode-solid electrolyte trilayers 350, 352 and a cathode-solid electrolyte bilayer 354 may be prepared by the dry compression technique as detailed in the first embodiment. A first Li metal anode 316 may be inserted between the open side of the solid electrolyte layer 314 of the bilayer 354 and the graphene-based bipolar membrane 340 of one of the trilayers 350. A second Li metal anode 326 may be inserted between the open side of the solid electrolyte layer 324 of the first trilayer 350 and the holey graphene-based bipolar membrane 352. A third Li metal anode 336 may be attached to the open side of the solid electrolyte layer 334 of the second trilayer 352. Encasing the three-unit-cell ensemble into a coin cell, a pouch cell, a cylindrical cell, or a split cell may form a tri-cell bipolar SSB stack 300.

In another embodiment (not depicted in the figures), a holey graphene film may be formed by directly compressing holey graphene powder in a compression die with the same or slightly larger size than that used to prepare cathode-solid electrolyte bilayer. The holey graphene film may be used as a bipolar membrane to separate two SSB unit cells formed by attaching a Li metal anode to the solid electrolyte side of a cathode-solid electrolyte bilayer formed by dry compression. The two-unit-cell ensemble with a holey graphene film bipolar membrane may form a dual-cell bipolar SSB stack in a coin cell, a pouch cell, a cylindrical cell, or a split cell.

In another embodiment (not depicted in the figures), a graphene membrane may be formed by vacuum filtration of a graphene solution onto a filter paper and cut into the same size as or slightly larger than the cathode-solid electrolyte bilayer. The graphene membrane may be used as a bipolar membrane to separate two SSB unit cells formed by attaching a Li metal anode to the solid electrolyte side of a cathode-solid electrolyte bilayer formed by dry compression. The two-unit-cell ensemble with a graphene membrane bipolar membrane may form a dual-cell bipolar SSB stack in a coin cell, a pouch cell, a cylindrical cell, or a split cell.

In another embodiment (not depicted in the figures), a carbon nanotube membrane may be formed by vacuum filtration of a carbon nanotube solution onto a filter paper and cut into the same or slightly larger size of the cathode-solid electrolyte bilayer. The carbon nanotube membrane may be used as a bipolar membrane to separate two SSB unit cells formed by attaching a Li metal anode to the solid electrolyte side of a cathode-solid electrolyte bilayer formed by dry compression. The two-unit-cell ensemble with a carbon nanotube membrane bipolar membrane may form a dual-cell bipolar SSB stack in a coin cell, a pouch cell, a cylindrical cell, or a split cell.

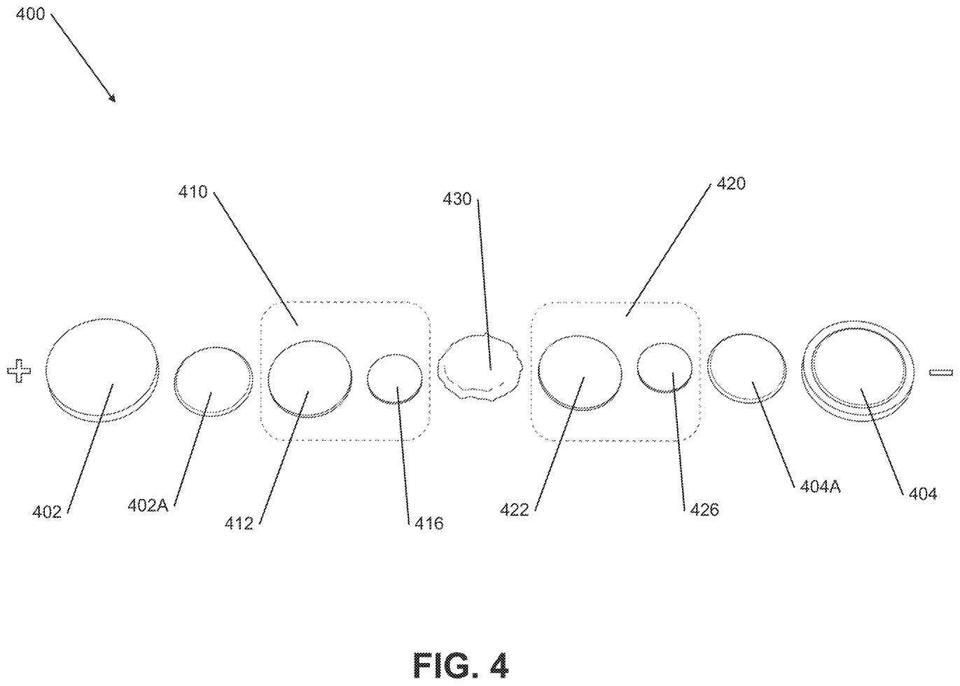

FIG. 4 depicts another exemplary embodiment of a dual-cell bipolar stack 400 architecture in this invention, with two unit cells 410, 420 separated by a carbon nanotube sheet bipolar membrane 430. The carbon nanotube sheet bipolar membrane 430 as depicted and described throughout may also be described as a foil, a sheet, a film, a plate, a layer, a laminate, a paper and/or any other structure that may be used to separate the unit cells 410, 420 without departing from the invention. The carbon nanotube sheet bipolar membrane 430 may be a hard surface or a soft surface. The carbon nanotube sheet bipolar membrane 430 may also be porous or non-porous. As depicted in FIG. 4, the carbon nanotube sheet bipolar membrane 430 may be used to separate unit cells 410, 420 of SSBs and provide serial electrical connection between adjacent unit cells. While FIG. 4 depicts a dual-cell bipolar SSB stack 100, the bipolar SSB stack 400 may include other numbers of cells, such as three, four, five, etc. cells. The bipolar SSB stack 400 may also have tens or even hundreds of bipolar cells if desired. The carbon nanotube sheet bipolar membrane 430 may include, but not be limited to, one or more of the following: graphite, expanded graphite, exfoliated graphite, graphene, holey graphene, graphene oxide, reduced graphene oxide, carbon platelets, carbon nanotubes, carbon fibers, carbon nanofibers, carbon nanoribbons, carbon nanobelts, carbon black, activated carbon, ketjen black, biomass carbons, ordered/disordered mesoporous carbon.

For the embodiments of FIG. 4, the features are referred to using similar reference numerals under the “4xx” series of reference numerals, rather than “1xx” as used in the embodiment of FIG. 1 and “3xx” as used in the embodiment of FIG. 3. Accordingly, certain features of the bipolar SSB stack 400 that were already described above with respect to the bipolar SSB stack 100 of FIG. 1 and the bipolar SSB stack 300 of FIG. 3 may be described in lesser detail, or may not be described at all.

FIG. 4 specifically illustrates a dual-cell bipolar stack 400 that includes a first unit cell 410 and a second unit cell 420 that are separated by a carbon nanotube sheet bipolar membrane 430. The first unit cell 410 may include a cathode-solid electrolyte bilayer 412 and an Li anode 416. Similarly, the second unit cell 420 may include a cathode-solid electrolyte bilayer 422 and an Li anode 426.

As illustrated in FIG. 4, the dual-cell bipolar stack 400 may include a cathode spacer 402A and a cathode current collector 402 adjacent to the first unit cell 410. The cathode current collector 402 may be located at a positive pole for the dual-cell bipolar stack 400. Additionally, the dual-cell bipolar stack 400 may include an anode spacer 404A and an anode current collector 404 adjacent to the second unit cell 420. The anode current collector 404 may be located at a negative pole for the dual-cell bipolar stack 400.

While the state-of-the-art bipolar plates use high density, heavy metals or less electrically conductive carbon-based composites, the direct use of conductive carbon nanomaterial films or membranes described in this invention allows bipolar membranes 430 to be fabricated with both high electrical conductivity and low density. These bipolar membranes 430 provide a significant improvement of SSB performance in both specific energy due to their lighter weights and specific power due to the high electrical conductivity. An important feature of this invention is that the carbon-based bipolar membranes 130 may be of low density, low mass loading, and low thickness. For example, the density may be <0.5-1.5 g/cm³ or less than 2.5 g/cm³. Additionally, the mass loading may be approximately 10 mg/cm²) and the thickness may be less than 100 μm). Several embodiments are introduced below as examples but not as limitations on how carbon-based bipolar membranes 430 are fabricated.

As illustrated in FIG. 4, a commercially available carbon nanotube sheet may be cut into the same or slightly larger size of the cathode-solid electrolyte bilayer 412, 422. The carbon nanotube sheet may be used as a bipolar membrane 430 to separate two SSB unit cells 410, 420 formed by attaching a Li metal anode 416, 426 to the solid electrolyte side of a cathode-solid electrolyte bilayer 412, 422 formed by dry compression. The two-unit-cell 410, 420 ensemble with a carbon nanotube sheet bipolar membrane 430 forms a bi-cell bipolar SSB stack 400 in a coin cell, a pouch cell, a cylindrical cell, or a split cell.

FIG. 4 shows the various components to be assembled into a dual-cell bipolar stack in a 2032-sized coin cell 400. The cell 400 may include two unit cell 410, 420 components and a carbon nanotube sheet-based bipolar membrane 430. The cathode-solid electrolyte bilayer 412, 422 may be made of a solid electrolyte layer and a cathode. The solid electrolyte layer from the cathode-solid electrolyte bilayer 412, 422 may be lithium phosphorous sulfide chloride (LPSCl). The cathode from the cathode-solid electrolyte bilayer 412, 422 may be sulfur-based solid-state cathode composite with hG as the carbon additive and LPSCl as the solid electrolyte additive. The anode 416, 426 may be Li metal. The solid electrolyte and the cathode may be pressed together to form the cathode-solid electrolyte bilayer 412, 422.

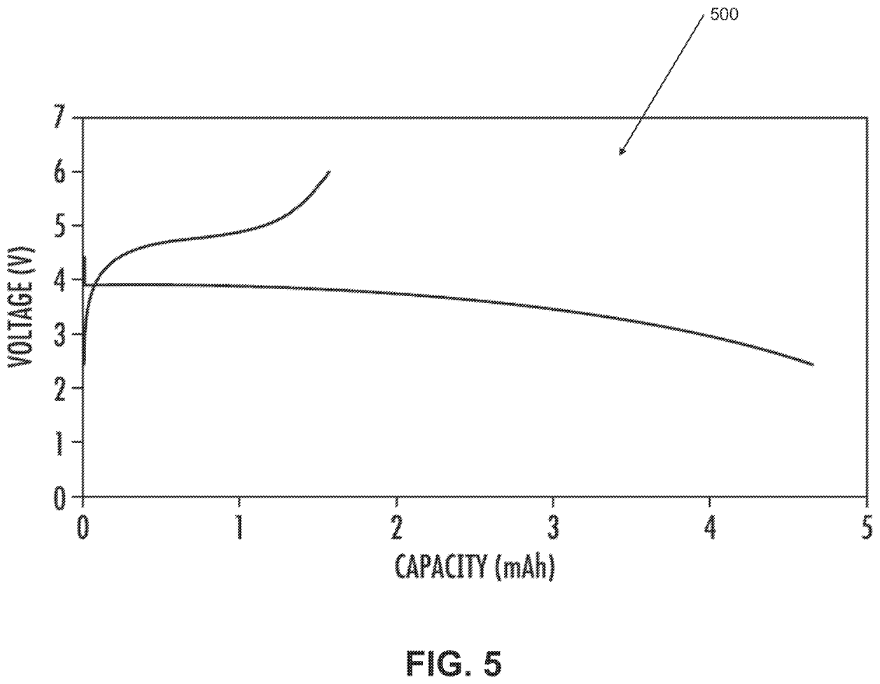

FIG. 5 illustrates an exemplary performance chart 500 of the bi-cell bipolar SSB stack 400 with the two-unit-cell 410, 420 ensemble and the carbon nanotube sheet bipolar membrane 430. Specifically, FIG. 5 shows data from the first discharge-charge cycle at room temperature (R.T.) of 2032-sized coin cell encased with a dual-cell bipolar stack 400 with a carbon nanotube sheet bipolar membrane (˜30 μm; ˜ 2.5 mg) 430. Cell capacity may reach nearly ˜4.7 mAh, or ˜1200 mAh/g-sulfur. The solid electrolyte layer may be lithium phosphorous sulfide chloride (LPSCl). The cathode may be sulfur-based solid-state cathode composite with hG as the carbon additive and LPSCl as the solid electrolyte additive. The anode may be Li metal.

In another embodiment, the fabricated carbon sheet (including but not limited to graphene, holey graphene, carbon nanotubes, etc.) is coated with a metallic (including but not limited to Al, Ni, Ti) or conducting ceramic (including but not limited to TiC, TiN, WC) layer to isolate one or more of the connected electrodes. The coating can be through physical vapor deposition, atomic layer deposition or similar to achieve coating thicknesses ˜1 micron or less and allow for tunable surface chemistry between active and inactive components. The added layer does not add any significant weight to the bipolar membrane because of its small thickness.

In another embodiment, the carbon sheet (including but not limited to graphene, holey graphene, carbon nanotubes, etc.) is further tuned for porosity (both particle and pellet porosities) to improve active electrode adhesion and electrochemical performance.

A unique feature of this invention is it uses films and membranes of carbon nanomaterials as bipolar membrane for SSBs. These films and membranes are lightweight, highly electrically conductive, mechanically robust, and sufficiently inert toward SSB electrochemical reactions. These unique characteristics enhance the basic bipolar membrane functions by providing improved specific energy and specific power of bipolar SSB stacks.

“Carbon bipolar plates” currently available commercially are all for fuel cells. Those fuel cell carbon bipolar plates are of completely different chemistry except for sharing the same name and one function, i.e., separating unit cells by electrically serialize them. Bipolar plats for fuel cells need to separate hydrogen and oxygen gas from cathode and anode compartments so the carbon bipolar plates cannot be porous. Therefore, the carbon bipolar plates for fuel cells need to be non-porous, such as hardened graphite or composite graphite, etc.

For SSBs, there is no need to separate gases, but the bipolar membranes need to be inert to the battery chemistry. Therefore, porous carbon can be directly used for the bipolar membranes for SSBs. In addition, the applicability of carbon to separate lithium metal-based unit cells is not obvious. For example, aluminum can be used as bipolar plates for fuel cells, but aluminum cannot be used for lithium metal batteries as it will react with the lithium. Carbon is also known to electrochemically react with lithium under certain conditions.

Carbon-based bipolar membranes are expected to have broad applications for various SSB chemistries and therefore significant commercial interest in battery manufacturers for electronics, electric vehicles, electric aircrafts, grid storage, and high voltage applications. The significant weight reduction due to carbon-based bipolar membranes is particularly attractive to the automotive sector. Several companies may produce or use carbon-based bipolar membranes for high performance SSBs.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

What is claimed is:

1. A solid-state battery comprising:
a plurality of unit cells, wherein each of the plurality of unit cells includes a cathode, an electrolyte, and an anode;
one or more carbon-based bipolar membranes, wherein each of the carbon-based bipolar membrane separates two of the plurality of unit cells;
a cathode current collector that provides a positive pole for the solid-state battery; and
an anode current collector that provides a negative pole for the solid-state battery.

2. The solid-state battery of claim 1, wherein the plurality of unit cells includes a first unit cell and a second unit cell.

3. The solid-state battery of claim 1, wherein the carbon-based bipolar membrane is a conductive carbon nanomaterial film.

4. The solid-state battery of claim 1, wherein the carbon-based bipolar membrane has a density of less than approximately 2.5 g/cm³.

5. The solid-state battery of claim 1, wherein the carbon-based bipolar membrane is coated with a metallic layer.

6. The solid-state battery of claim 5, wherein the metallic layer includes one or more of: aluminum (Al), nickel (Ni), or titanium (Ti).

7. The solid-state battery of claim 1, wherein the carbon-based bipolar membrane is coated with a conducting ceramic layer.

8. The solid-state battery of claim 7, wherein the conducting ceramic layer includes one or more of titanium-carbide (TIC), titanium-nitride (TiNi), or tungsten-carbide (WC).

9. The solid-state battery of claim 1, wherein the carbon-based bipolar membrane is a holey graphene powder that is directly pressed with a sulfur-based solid-state cathode composite powder and a solid electrolyte lithium phosphorous sulfide chloride powder using a solvent-free dry compression process, thereby forming a holey graphene-cathode-solid electrolyte trilayer.

10. The solid-state battery of claim 9, wherein a first lithium metal anode is attached to a solid electrolyte layer side of the holey graphene-cathode-solid electrolyte trilayer to form a first unit cell with a, where the holey graphene layer serves as the carbon-based bipolar membrane.

11. The solid-state battery of claim 10, wherein a second lithium metal anode is attached to a cathode-solid electrolyte bilayer using the solvent-free dry compression process, thereby forming a second unit cell.

12. The solid-state battery of claim 11, wherein the second lithium metal anode of the second unit cell contacts a holey graphene of the carbon-based bipolar membrane.

13. The solid-state battery of claim 1, wherein the carbon-based bipolar membrane is tuned for a porosity to improve an active electrode adhesion and an electrochemical performance.

14. A solid-state battery comprising:
a first holey graphene-cathode-solid electrolyte trilayer, wherein the first holey graphene-cathode-solid electrolyte trilayer includes a first holey graphene powder that is directly pressed with a first sulfur-based solid-state cathode composite powder and a first solid electrolyte lithium phosphorous sulfide chloride powder using a solvent-free dry compression process;
a second holey graphene-cathode-solid electrolyte trilayer, wherein the second holey graphene-cathode-solid electrolyte trilayer includes a second holey graphene powder that is directly pressed with a second sulfur-based solid-state cathode composite powder and a second solid electrolyte lithium phosphorous sulfide chloride powder using the solvent-free dry compression process;
a cathode-solid electrolyte bilayer including a third sulfur-based solid-state cathode composite powder and a third solid electrolyte lithium phosphorous sulfide chloride powder compressed together using the solvent-free dry compression process, thereby forming a second unit cell;
a first lithium metal anode inserted between an open side of the third solid electrolyte lithium phosphorous sulfide chloride powder of the cathode-solid electrolyte bilayer and the first holey graphene powder of the first holey graphene-cathode-solid electrolyte trilayer;
a second lithium metal anode inserted between an open side of the first solid electrolyte lithium phosphorous sulfide chloride powder of the first holey graphene-cathode-solid electrolyte trilayer and the second holey graphene powder of the second holey graphene-cathode-solid electrolyte trilayer; and
a third lithium metal anode attached to an open side of the second solid electrolyte lithium phosphorous sulfide chloride powder of the second holey graphene-cathode-solid electrolyte trilayer.

15. The solid-state battery of claim 14 further comprising:
a cathode current collector that provides a positive pole for the solid-state battery; and
an anode current collector that provides a negative pole for the solid-state battery.

16. The solid-state battery of claim 14, wherein the first holey graphene powder and the second holey graphene powder are coated with a metallic layer that includes one or more of the following: aluminum (Al), nickel (Ni), or titanium (Ti).

17. The solid-state battery of claim 14, wherein the first holey graphene powder and the second holey graphene powder are coated with a conducting ceramic layer that includes one or more of the following: titanium-carbide (TiC), titanium-nitride (TiNi), or tungsten-carbide (WC).

18. A solid-state battery comprising:
a first unit cell component that includes a first lithium anode attached to a solid electrolyte side of a first cathode-solid electrolyte bilayer formed by a solvent-free dry compression process;
a second unit cell component that includes a second lithium anode attached to a solid electrolyte side of a second cathode-solid electrolyte bilayer formed by the solvent-free dry compression process; and
a carbon nanotube sheet bipolar membrane that separates the first unit cell and the second unit cell and provides a serial electrical connection between the first unit cell and the second unit cell.

19. The solid-state battery of claim 18, wherein the carbon nanotube sheet bipolar membrane is coated with either coated with 1) a metallic layer that includes one or more of the following: aluminum (Al), nickel (Ni), or titanium (Ti); or 2) a conducting ceramic layer that includes one or more of the following: titanium-carbide (TIC), titanium-nitride (TiNi), or tungsten-carbide (WC).

20. The solid-state battery of claim 18 further comprising:
a cathode current collector adjacent to the first unit cell; and
an anode current collector adjacent to the second unit cell.
